(19) United States
(12) Patent Application Publication
(10) Pub. No.: US 2004/0081788 A1
(43) Pub. Date: Apr. 29, 2004

(54) Two-sided lamination tape for use in see through mounting

(76) Inventor: Michael Sudofsky, Mattapoisctt, MA (US)

Correspondence Address: Richard C. Woodbridge, Esq., Synnestvedt Lechner & Woodbridge, LLP, P.O. Box 592, Princeton, NJ, 08542-0592, US

(21) Appl. No.: 10/690,676

(22) Filed: Oct. 22, 2003

Related U.S. Application Data
(60) Provisional application No. 60/420,468, filed on Oct. 22, 2002.

(51) Int. Cl. B32B 9/00

(52) U.S. Cl. 428/40.1

(57) ABSTRACT

A two-sided lamination tape for high quality face mounting of graphics. The tape has a very clear thermally activated adhesive surface on one side of a support film and a perfectly clear pressure sensitive adhesive on the other side. The tape is laminated to the image surface of a graphic by means of the clear, thermally activated surface. The laminated graphic can then be face mounted by means of the perfectly clear, tacky pressure sensitive adhesive side. The tacky, pressure sensitive adhesive allows momentary repositioning, giving the graphic user the ability to correct and smooth the mounted graphic. In the preferred embodiment, there is also a removable, protective film liner. This protective film allows storage of the laminated graphic and is peeled off just prior to use to expose the PSA layer.

### CROSS REFERENCE TO RELATED APPLICATIONS

This application claims the priority of U.S. Provisional Application Serial No. 60/420,468 entitled “Clear heat seal film/PSA/protective film liner” filed on Oct. 22, 2002, the entire contents and substance of which are hereby incorporated in total by reference.

### FIELD OF THE INVENTION

This invention relates to transparent, double-sided mounting films, and more particularly to transparent, double sided mounting films having one pressure sensitive adhesive side and one thermally activated adhesive side.

### BACKGROUND OF THE INVENTION

Face mounting is a well known technique in the graphics and image mounting and display industries in which a graphic's image surface is attached to a clear substrate, such as glass or an acrylic or polycarbonate sheet. The technique allows back lighting of the graphic and is also useful in lenticular imaging displays.

A common method of face mounting an image is to use a double side, Pressure Sensitive Adhesive (PSA) tape between the image surface of the graphic being mounted and the transparent substrate the image is being attached to Double sided adhesive tapes are well known, and are described in, for instance, U.S. Pat. No. 4,839,206 titled “Double Sided Adhesive Tape” issued to Waldneburger on June 13^{th}, 1989 and in U.S. Pat. No. 5,372,865 titled “Double-sided pressure-sensitive adhesive tape, laminated structure comprising the same, and method of use of same”, issued to Arakawa et al. on December 13^{th}, 1994, the contents of both of which are hereby incorporated by reference.

However, the double-sided PSA tapes used in face-mount graphics applications have to be extremely transparent, especially when used for corporate marketing purposes. One such extremely transparent double-sided tape used is Facemount(™), supplied by Drytac, Inc. in Richmond, Va. The exacting manufacturing tolerances required to produce double sided tape and film with the required transparency makes such films expensive.

What is needed is an inexpensive film material that allows high quality face-mounting of graphics.

### SUMMARY OF THE INVENTION

Briefly described, the invention comprises a two-side lamentation tape for use in see through mounting. The tape of this invention has a very clear thermally activated adhesive surface on one side of a support film and a perfectly clear pressure sensitive adhesive on the other side. The tape may be laminated to the image surface of a graphic by means of the clear, thermally activated surface. The laminated graphic can then be face mounted by means of the perfectly clear, tacky pressure sensitive adhesive side. The tacky, pressure sensitive adhesive allows momentary repositioning, giving the graphic user the ability to correct and smooth the mounted graphic.

In the preferred embodiment, there is a removable, protective film liner. This protective film has a release liner on one surface, which is coated with a perfectly clear pressure sensitive adhesive. A support film having a thermally activated adhesive on one side is then; sandwiched together with the PSA coated protective layer, such that the support film is in contact with the pressure sensitive adhesive layer, and the thermally activated adhesive layer is exposed. The result is a film or tape that can be thermally bonded to the image or face side of a graphic using well known laminating equipment. After thermal bonding to the graphic, the PSA layer still has a protective covering, allowing storage of the laminated graphic. Just prior to mounting the graphic, the protective covering is peeled off, exposing the PSA layer.

Having only one PSA layer results in a simpler, more easily manufactured tape suitable for high quality face mounting of graphics.

The invention may be more fully understood by reference to the following drawings.

### BRIEF DESCRIPTION OF THE DRAWINGS

FIG. 1 is a cross-sectional view of a two-sided lamination tape of this invention.

FIG. 2 is a cross-sectional view of a graphic thermally laminated to the two-sided lamination tape.

FIG. 3 is a cross-sectional view of a graphic thermally laminated to the two-sided lamination tape and with the protective layer peeled off to reveal the pressure sensitive adhesive layer.

FIG. 4 is a cross-sectional view of a graphic face mounted to a transparent window by means of a two-sided lamination tape of this invention.

FIG. 5 is a schematic view of a method of making the tape.

### DETAILED DESCRIPTION

During the course of this description like numbers will be used to identify like elements according to the different views that illustrate the invention.

The tape of this invention is intended for uses such as, but not limited to, high quality surface mounting of graphics to transparent supports. Such mounting is often used to create backlit displays at for instance, marketing conventions. The tape of this invention enables face mounting by having a very clear thermally activated adhesive surface on one side of a support film and a perfectly clear pressure sensitive adhesive on the other side. This allows the tape to be thermally attached to the face of the graphic, and the graphic, after a protective layer has been peeled off, to be attached to a see through support by a pressure sensitive adhesive.

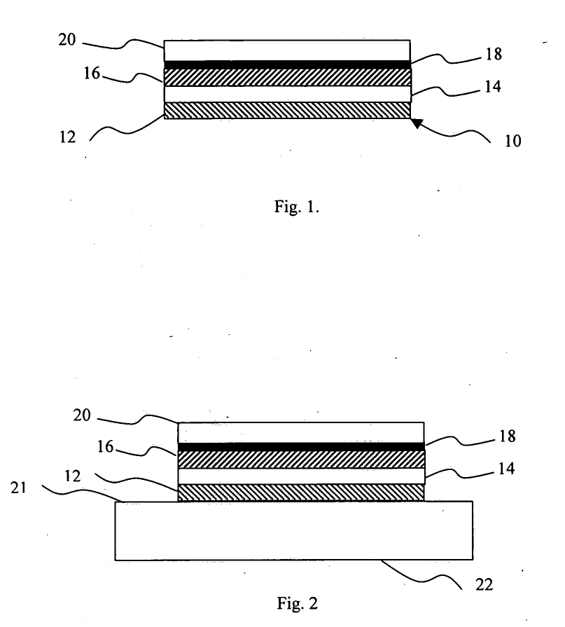

FIG. 1 is a cross-sectional view of a two-sided lamination tape 10 of this invention. The tape 10 comprises a film carrier 14, a thermally activated layer 12, a Pressure Sensitive Adhesive (PSA) layer 16 and a protective layer 20 having a release coating 18 on one surface. As shown in FIG. 1, the layers are arranged so that the surface of the protective layer 20 having the release coating 18 is in contact with the layer of PSA 16 coating the carrier film 14. The thermally activated adhesive layer 12 is attached to the surface of the other surface of carrier film.

In a preferred embodiment of the invention the carrier film 14 is a clear grade, free of defects flexible polymer film such as, but not limited to nylon or polyester, about 0.5 mils thick. The thermally activated layer 12 is and Ethyl Vinyl Acetate (EVA) layer, about 1.2 mil thick when dry. The EVA layer has an activation temperature in the range of about 170 to 225 degrees Fahrenheit. This activation temperature cane be varied by blending with, for instance, polyethylene (PE). The current preferred activation temperature is 190 degrees Fahrenheit. Layer 16 is an acrylic based PSA that is “water clear”, i.e. has a tint on the Gardner Scale of 0. Examples of such PSA's are Ashland Specialty Chemical Company of Dublin, Ohio's AROSET® lines of water-based, clear-label adhesives. For example, a blend of between 30-70% by weight of AROSET N1040 with the remainder comprising N1042 provides a suitable PSA, with the ratio determining peel strength. The protective layer 20 is a 1.5 mil thick Polyethylene Terephthalate (PET) layer with a silicone release layer 18. It is important that even the protective layer 20 is a flat film and preferably of “window film” grade, that is the grade used for tinting car windows.

In one embodiment of the invention, the PSA layer 16 is constituted to have a bond strength to glass that is less than 40 ounces per square inch by varying the ration the blend detailed above.

In another embodiment of the invention, the PSA layer 16 is constituted to have a bond strength to glass that is less than 18 ounces per square inch by varying the ration the blend detailed above.

FIG. 2 is a cross-sectional view showing how the two-sided tape of this invention is attached to the image surface 21 of a graphic 22. The image surface 21 is placed in contact with the thermally activated layer 12. The sandwich of tape and graphic is then heated to the thermal activation temperature under slight pressure, as is standard in the art of plastic lamination, as described in for instance, U.S. Pat. No. 5,858,510 titled “Photographic pouch lamination” issued to Dressler on Jan. 12, 1999, the contents of which are hereby incorporated by reference. The result is that the tape 10 adheres to the image side 21 of the graphic 22.

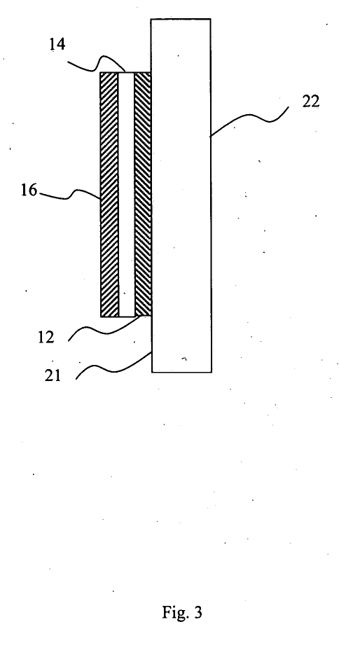

FIG. 3 is a cross-sectional showing a graphic 22 with image side 21 thermally laminated to the two-sided lamination tape 110 and with the protective layer peeled off to reveal the pressure sensitive adhesive layer 16. The graphic 22 is now ready for face mounting to a support.

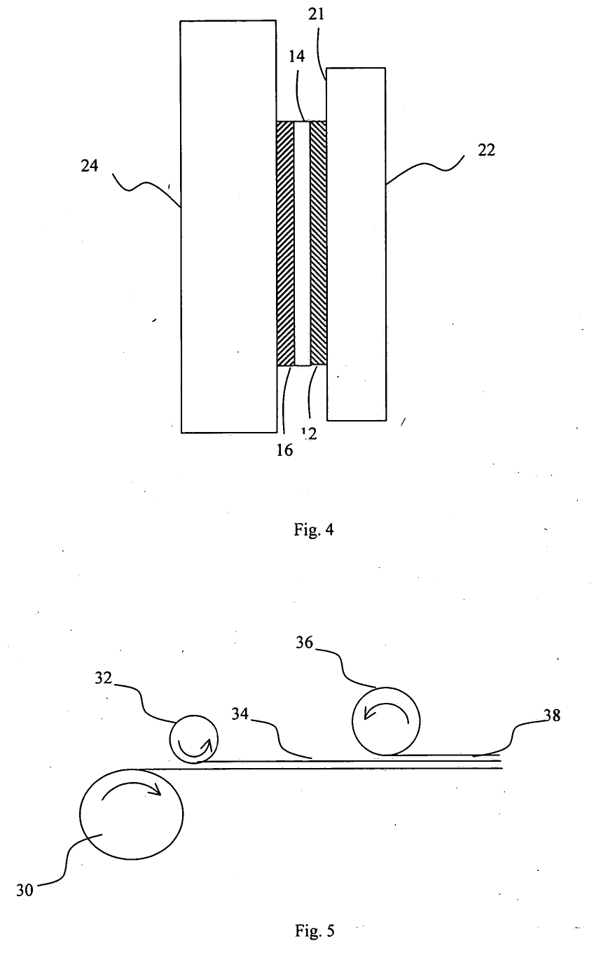

FIG. 4 shows a cross-sectional view of a graphic 22 now attached to a clear support 24, such a glass or plexiglass plate. Because the supporting film 14, the thermal adhesive 12 and the PSA 16 are all “water clear”, the image surface 21 of the front mounted graphic 22 is clearly visible through the clear support 24.

FIG. 5 is a schematic view of one method of making the two-faced tape of this invention. A reel 30 containing the protective film 20 with release layer 18 is feed past a roll of PSA layer 16 material, which is coated on to the release layer. The sandwich of protective film, release layer and PSA coating 34 then has a material floated onto top of it. The material is drawn from a reel 36 containing a support film with thermally activated adhesive already coated on it. The film is drawn from the reel 36 so that the support film floats onto the PSA coating, resulting in the two-sided tape with protective layer 38.

While the invention has described with specific film thickness, it would be apparent to one of skill in the art that each thickness could be varied considerably and the tape still be functional. For instance, the heat seal layer 12 may vary from 0.2 to 3 mil and still be effective. Similarly, the support layer 14 and PSA layers 16 could vary from 0.2 to 5 mil and still be effective. The protective layer 20 could vary from 0.2 mil to 2 mil and still be effective, and could for some applications, be of similar thickness to the graphic.

While the invention has been described with reference to the preferred embodiment thereof, it will be appreciated by those of ordinary skill in the art that modifications can be made to the structure and elements of the invention without departing from the spirit and scope of the invention as a whole.

What is claimed is:

1. A clear mounting film, comprising:
a release liner having an upper and a lower surface, at least the upper of which is a release surface;
a layer of pressure sensitive adhesive applied to said upper release surface;
a support layer applied to said pressure sensitive adhesive layer; and
a layer of thermally activated adhesive applied to said support layer, said film having a shape such that said film may be used effectively as a clear mounting film.

2. The mounting film of claim 1 wherein said pressure sensitive adhesive, said support layer and said thermally activated adhesive are each substantially transparent to visible light.

3. The mounting film of claim 1 wherein said pressure sensitive adhesive, said support layer and said thermally activated adhesive are each substantially water clear.

4. The mounting film of claim 2, wherein said thermally activated adhesive has an activation temperature in the range less than 225 degrees Fahrenheit.

5. The mounting film of claim 4 wherein said thermally activated adhesive is 0.2 mil to 5 mil thick.

6. The mounting film of claim 4 wherein said thermally activated adhesive is an Ethyl Vinyl Acetate film.

7. The mounting film of claim 2 wherein said pressure sensitive adhesive layer is 0.2 to 2 mils thick.

8. The mounting film of claim 2 wherein said pressure sensitive adhesive layer is an acrylic polymer.

9. The mounting film of claim 2 wherein said release liner is 0.2 to 2 mils thick.

10. The mounting film of claim 2 wherein said release liner is Polyethylene Terephthalate.

11. The mounting film of claim 2 wherein said release liner is window grade smooth.

12. The mounting film of claim 2 wherein said pressure sensitive adhesive layer has a bond strength to glass less than 40 ounces per inch.

13. A method of face mounting a graphic, comprising the steps of:
attaching a clear two-sided mounting film to said graphic using a thermally activated adhesive surface of said two-sided mounting film;
removing a protective layer from said thermally attached two-side mounting film to reveal a pressure sensitive adhesive layer of said clear two-sided mounting film; and
attaching said graphic to a clear support by means of said pressure sensitive adhesive layer.

14. The method of claim 13 wherein said pressure sensitive adhesive and said thermally activated adhesive are each substantially water clear.

15. The method of claim 14 wherein said thermally activated adhesive is an Ethyl Vinyl Acetate film, 0.2 to 2 mils thick.

16. The method of claim 15 wherein said pressure sensitive adhesive layer is an acrylic polymer, 0.2 to 2 mils thick.

17. A method of making a two-sided tape, comprising:
coating a pressure sensitive layer on to a release liner having an upper and a lower surface, at least the upper of which is a release surface; and
floating a film comprising a support layer applied having a layer of thermally activated adhesive pre-applied to said support layer, such that said support layer contacts said pressure sensitive layer.

18. The method of claim 17 wherein said pressure sensitive adhesive, said support layer and said thermally activated adhesive are each substantially transparent to visible light.

19. The method of claim 18 wherein said thermally activated adhesive is an Ethyl Vinyl Acetate/Polyethylene blend film, 0.2 to 2 mils thick.

20. The method of claim 18 wherein said pressure sensitive adhesive layer is an acrylic polymer, 0.2 to 2 mils thick.
